(19) United States
(12) Patent Application Publication
(10) Pub. No.: US 2025/0051156 A1
(43) Pub. Date: Feb. 13, 2025

(54) HYDROGEN PRODUCTION

(71) Applicant: Breakthrough Technologies, LLC, Boston, MA (US)

(72) Inventor: Kamal Jaffrey, Winchester, MA (US)

(21) Appl. No.: 18/720,035

(22) PCT Filed: Dec. 9, 2022
(86) PCT No.: PCT/US2022/052384

§ 371 Date: Jun. 14, 2024

Related U.S. Application Data
(60) Provisional application No. 63/289,920, filed on Dec. 15, 2021.

(51) Int. Cl. C01B 3/04; B01J 19/12; C01B 3/50

(52) U.S. Cl. CPC C01B 3/042; B01J 19/123; B01J 19/126; C01B 3/503; B01J 2219/1269; C01B 2203/0855

(57) ABSTRACT

Systems for the production of hydrogen and/or oxygen are provided. In one exemplary embodiment, a system can include a first chamber, a microwave source configured to radiate microwave energy into at least the first chamber, a second chamber in communication with the first chamber, and an ultraviolet light source. The second chamber includes an outlet and a waveguide, and the ultraviolet light source resides within the waveguide of the second chamber. The first chamber includes an inlet that allows an input feed to enter the first chamber, the input feed including water. The ultraviolet light source is configured to emit ultraviolet light to at least partially breakdown the water into hydrogen gas and oxygen gas as the water flows through the second chamber. Methods for the production of hydrogen and/or oxygen are also provided.

### CROSS-REFERENCE TO RELATED APPLICATIONS

This application claims priority to U.S. Provisional Patent Application No. 63/289,920 filed on Dec. 15, 2021, and entitled “Hydrogen Peroxide,” the disclosure of which is incorporated herein by reference in its entirety.

### TECHNICAL FIELD

The subject matter described herein relates to producing hydrogen and/or oxygen from water.

### BACKGROUND

Hydrogen is widely used in a variety of different industries, such as oil refining, ammonia production, methanol production and steel production, transportation, and building materials. Hydrogen can be produced from renewable resources (e.g., hydro, wind, solar, etc.) and nonrenewable resources (e.g., coal, natural gas, etc.).

Conventional hydrogen production methods include steam reforming (e.g., of natural gas), coal gasification, partial oxidation (e.g., of heavy hydrocarbons, such as oil), thermochemical cycling, photolysis (e.g., solar photolysis), and electrolysis.

### SUMMARY

Systems are provided. In one exemplary embodiment, a system can include a first chamber, a microwave source configured to radiate microwave energy into at least the first chamber, a second chamber in communication with the first chamber, and an ultraviolet light source. The second chamber includes an outlet and a waveguide, and the ultraviolet light source resides within the waveguide of the second chamber. The first chamber includes an inlet that allows an input feed to enter the first chamber, the input feed including water. The ultraviolet light source is configured to emit ultraviolet light to at least partially breakdown the water into hydrogen gas and oxygen gas as the water flows through the second chamber.

In some embodiments, the water can be in the form of a vapor. In some embodiments, the water can in the form of an aerosol.

In some embodiments, the microwave source can be further configured to radiate the microwave energy into the waveguide of the second chamber such that the microwave energy contacts the ultraviolet light source, and wherein the ultraviolet light source can include an internal gas that generates the ultraviolet light upon contact with the microwave energy.

In some embodiments, the waveguide can include an end configured such that the microwave energy forms a standing wave within the waveguide.

In some embodiments, the second chamber can further include, a first electrode configured to have a negative charge; and a second electrode configured to have a positive charge, the first electrode and the second electrode being external to the ultraviolet light source and internal to the waveguide.

In some embodiments, the system can further include a tube assembly within the waveguide and containing the ultraviolet light source, in which the tube assembly includes a wall that is at least partially transparent to ultraviolet light and microwave energy.

In some embodiments, the first chamber can be located between the microwave source and the second chamber such that the microwave energy is generated by the microwave source and the microwave energy passes through the first chamber to the second chamber.

In some embodiments, the second chamber can include a plurality of tube assemblies extending therethrough and the ultraviolet light source includes a plurality of ultraviolet light sources. Each tube assembly can include a tube assembly outlet, a wall that is transparent to ultraviolet light and microwave energy, and a respective one ultraviolet light source of the plurality of ultraviolet light sources, the respective one ultraviolet light source including internal gas that generates ultraviolet light upon contact with microwave energy. The microwave source can be configured to radiate the microwave energy into the first chamber and into the plurality of tube assemblies such that the microwave energy contacts the plurality of ultraviolet light sources to cause the internal gas therein to generate ultraviolet light upon contact with the microwave energy.

In some embodiments, the system can further include a water source coupled to the inlet and a gas separator coupled to the outlet and configured to separate hydrogen gas from oxygen gas. In some embodiments, the gas separator can be hydrocyclone. In some embodiments, the gas separator can include a permeable membrane configured to at least partially separate the hydrogen gas from at least the oxygen gas such that the separated hydrogen gas ventilates through an outlet of the gas separator

In some embodiments, the ultraviolet light source can radiate the ultraviolet light having a wavelength range from about 150 nm to 200 nm.

In some embodiments, the ultraviolet light source can radiate the ultraviolet light having a wavelength of 185 nm.

In some embodiments, the second chamber can be elongate and extends along a primary axis, the ultraviolet light source can be elongate along the primary axis and resides within the second chamber along the primary axis. The second chamber can further include a first electrode configured to have a negative charge; and a second electrode configured to have a positive charge, the first electrode and the second electrode being external to the ultraviolet light source and internal to the waveguide. The first electrode can be elongate along the primary axis and arranged above the ultraviolet light source, and the second electrode can be elongate along the primary axis and arranged below the ultraviolet light source.

In some embodiments, the second chamber can form a hydrocyclone. In such embodiments, the ultraviolet light source can reside on a vortex finder located within the hydrocyclone.

In some embodiments, the system can include a permeable membrane residing within the second chamber, in which the permeable membrane at least partially separates the hydrogen gas from at least the oxygen gas such that the separated hydrogen gas ventilates through the outlet of the second chamber

Methods are also provided. In one exemplary embodiment, the method can include providing water into a first chamber adjacent to and in communication with a second chamber and a microwave source radiating microwave energy into the first chamber; contacting the water with microwave energy generated by a microwave source; providing the microwaved water to the second chamber, the second chamber including an outlet and a waveguide, wherein an ultraviolet light source resides within the waveguide of the second chamber; and contacting the microwaved water with ultraviolet light within the second chamber, the ultraviolet light generated by the ultraviolet light source, the microwave source configured to radiate the microwave energy into the first chamber, wherein contacting of the water with the ultraviolet light causes the water to at least partially breakdown into hydrogen gas and oxygen gas.

In some embodiments, the method further includes separating the hydrogen gas from the oxygen gas. In such embodiments, the separation of hydrogen gas from the oxygen gas can occur within the second chamber. In such embodiments, the second chamber can include a permeable membrane, in which the permeable membrane at least partially separates the hydrogen gas from at least the oxygen gas such that the separated hydrogen gas ventilates through an outlet of the second chamber.

In some embodiments, the separation of hydrogen gas from the oxygen gas can occur within a gas separator that is coupled to and in fluid communication with the second chamber. In such embodiments, the gas separator includes a permeable membrane, in which the permeable membrane at least partially separates the hydrogen gas from at least the oxygen gas such that the separated hydrogen gas ventilates through an outlet of the gas separator.

### DESCRIPTION OF DRAWINGS

This invention will be more fully understood from the following detailed description taken in conjunction with the accompanying drawings, in which:

This invention will be more fully understood from the following detailed description taken in conjunction with the accompanying drawings, in which:

### DESCRIPTION OF DRAWINGS

This invention will be more fully understood from the following detailed description taken in conjunction with the accompanying drawings, in which:

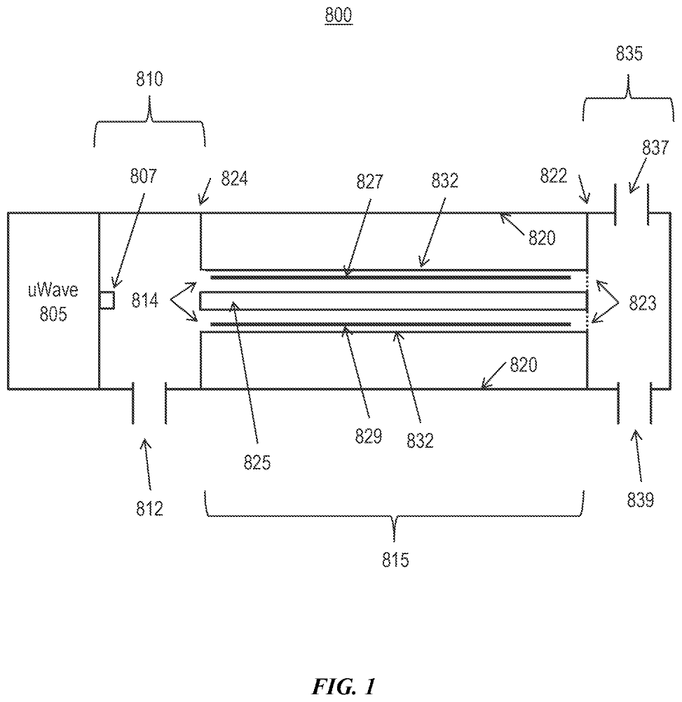

FIG. 1 is a longitudinal cross section of an example photo-reactor for decomposing water into hydrogen gas and oxygen gas.

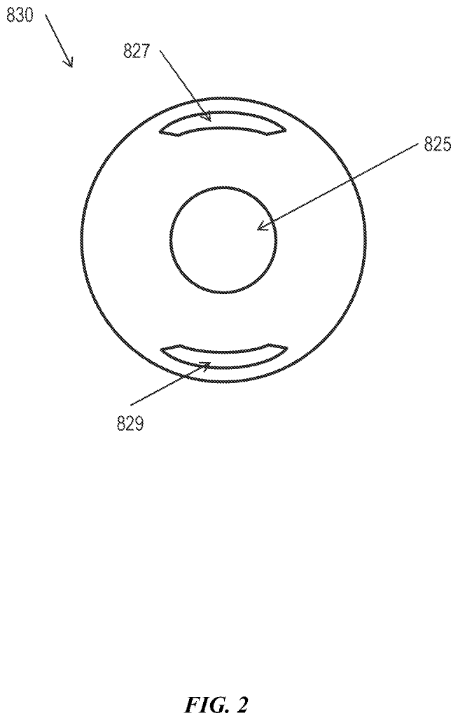

FIG. 2 is a cross-sectional view of a tube assembly.

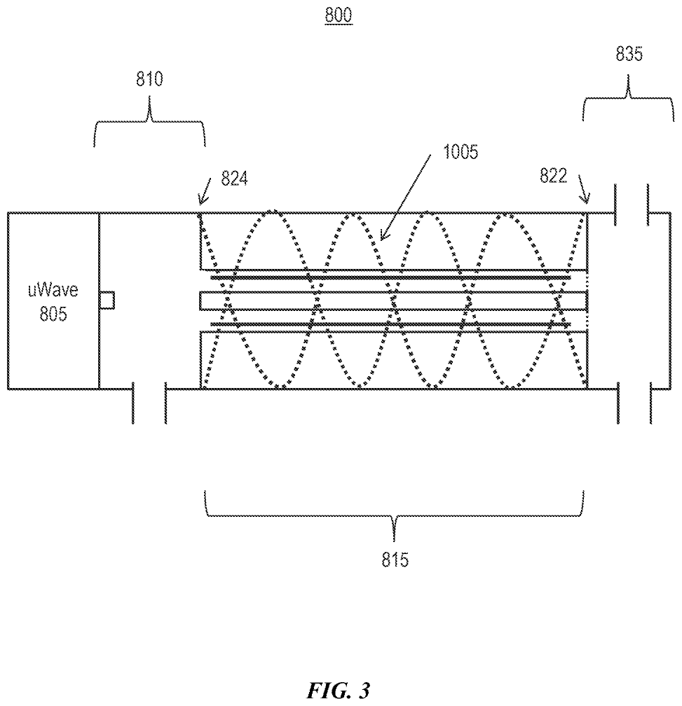

FIG. 3 illustrates the photo-reactor of FIG. 1 with a standing wave.

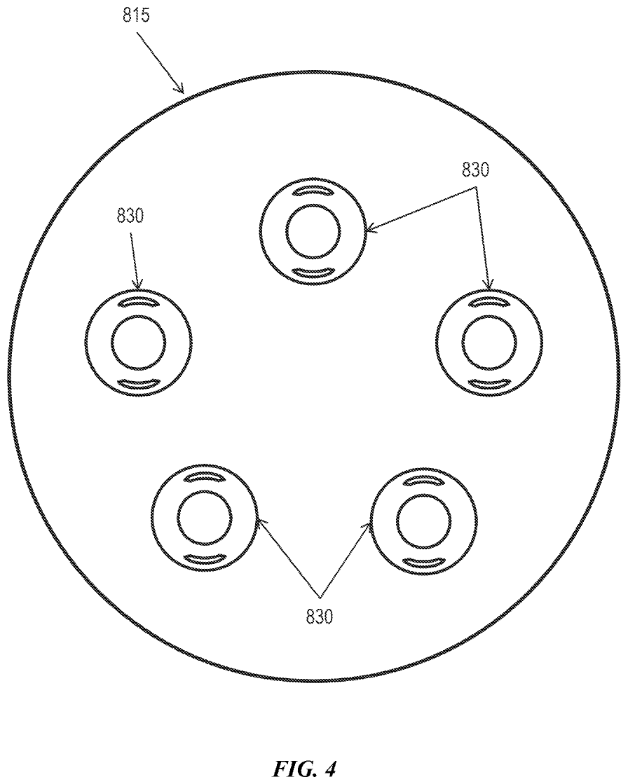

FIG. 4 is a cross-sectional view of another example photo-reactor having multiple tube assemblies.

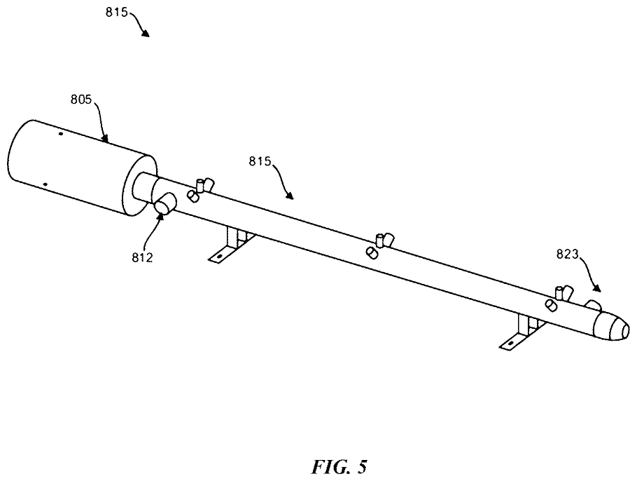

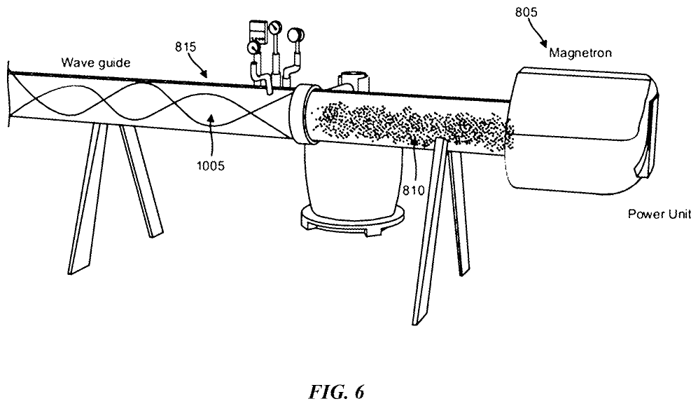

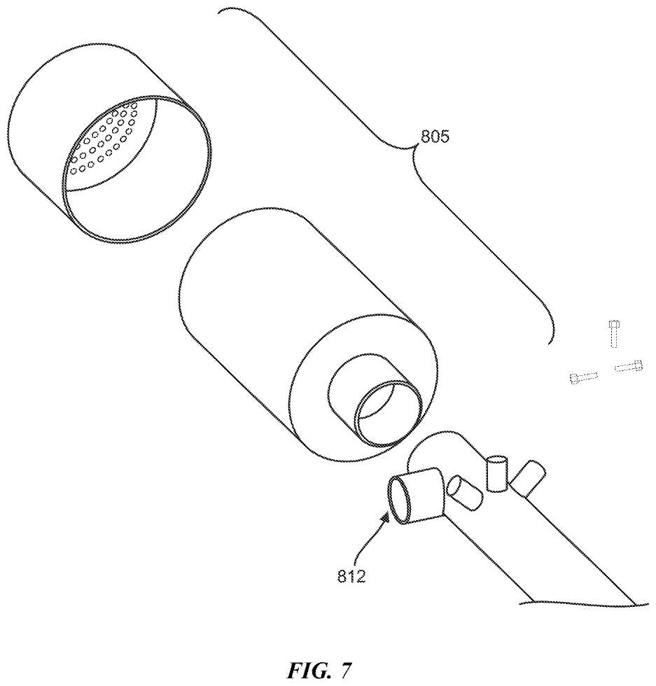

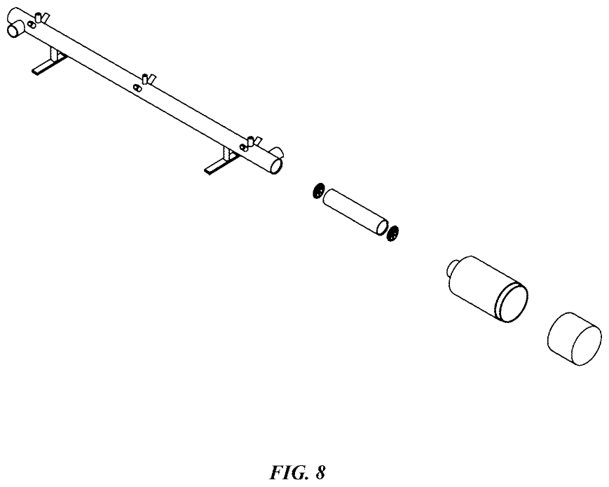

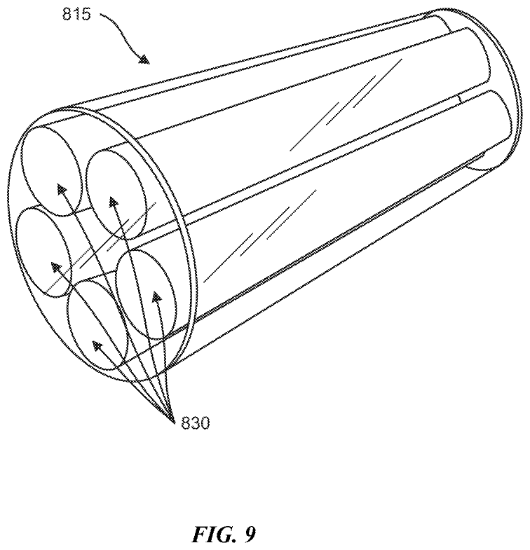

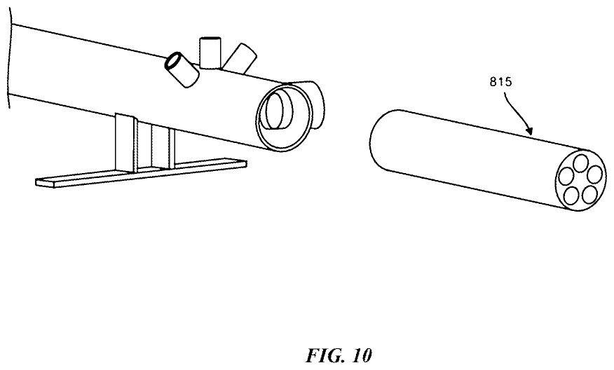

FIGS. 5-10 are views of an example photo-reactor according to some implementations of the current subject matter.

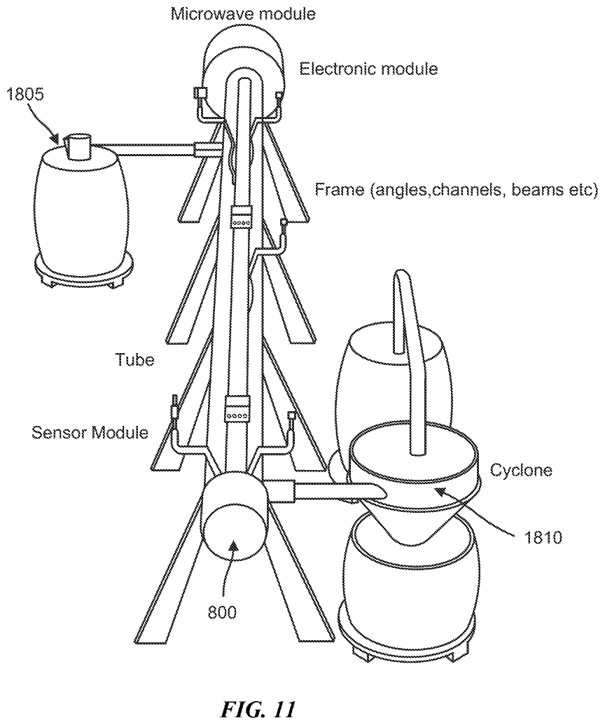

FIG. 11 illustrates an example system for decomposing water.

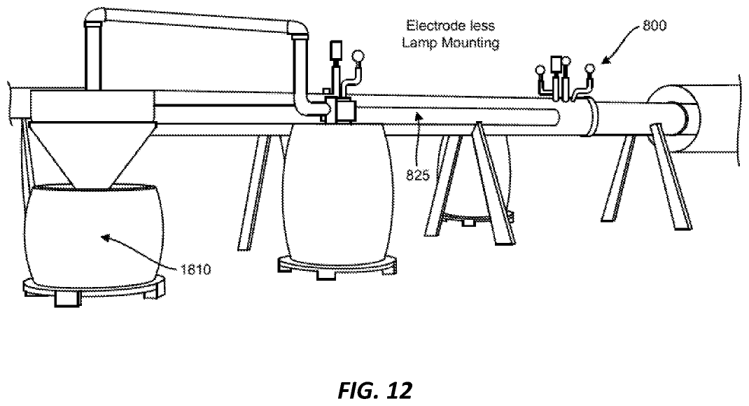

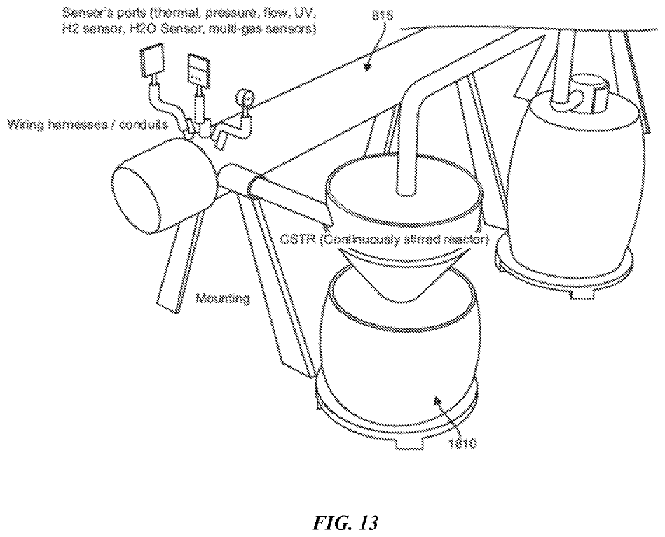

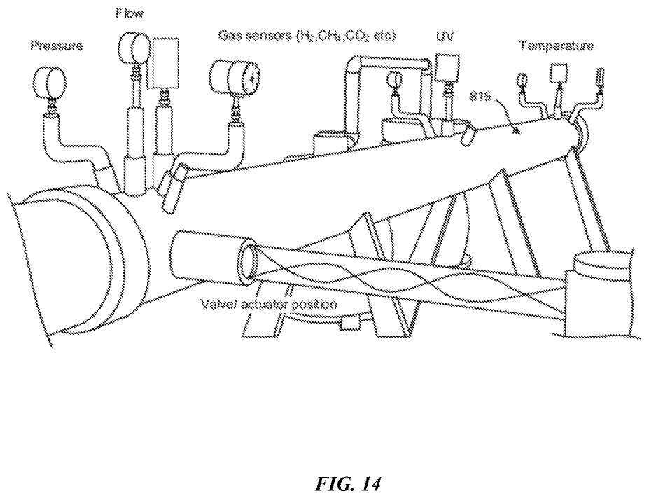

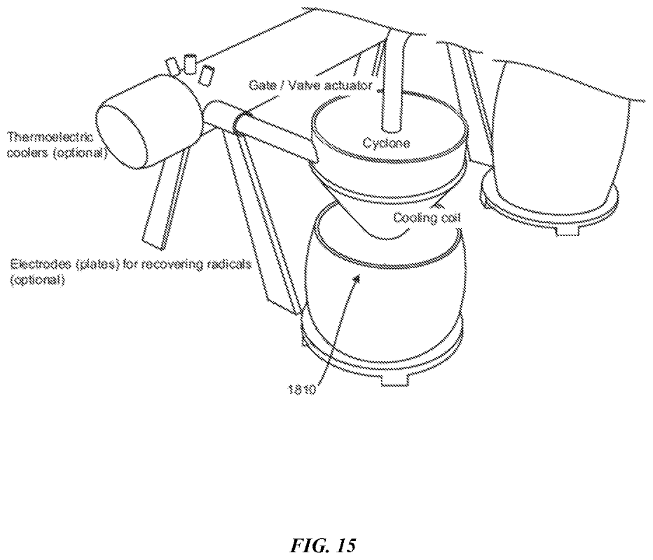

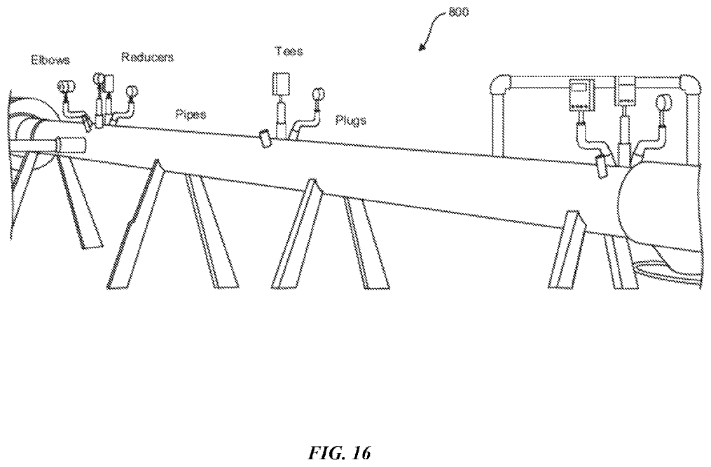

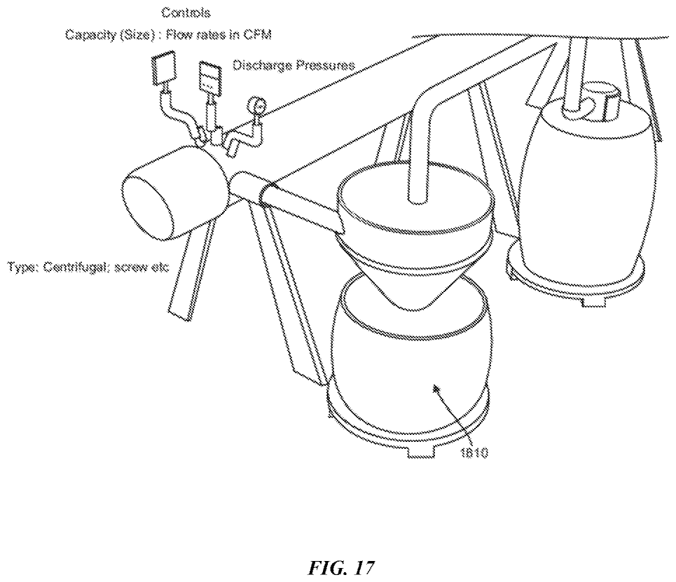

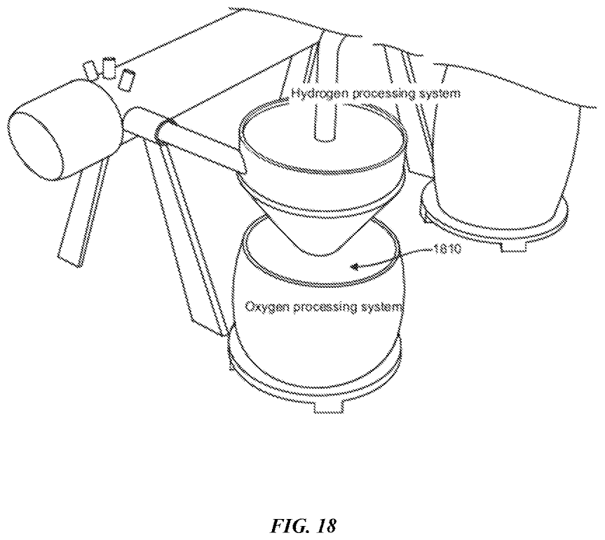

FIGS. 12-18 illustrate various views of the example system of FIG. 11.

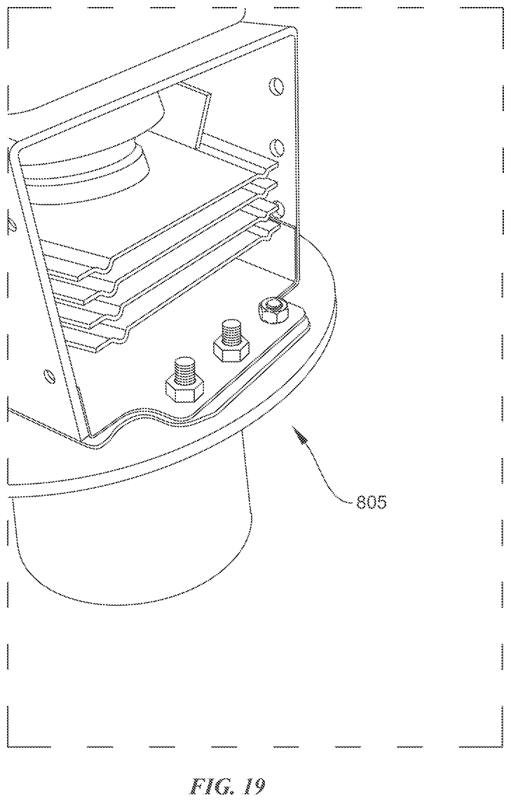

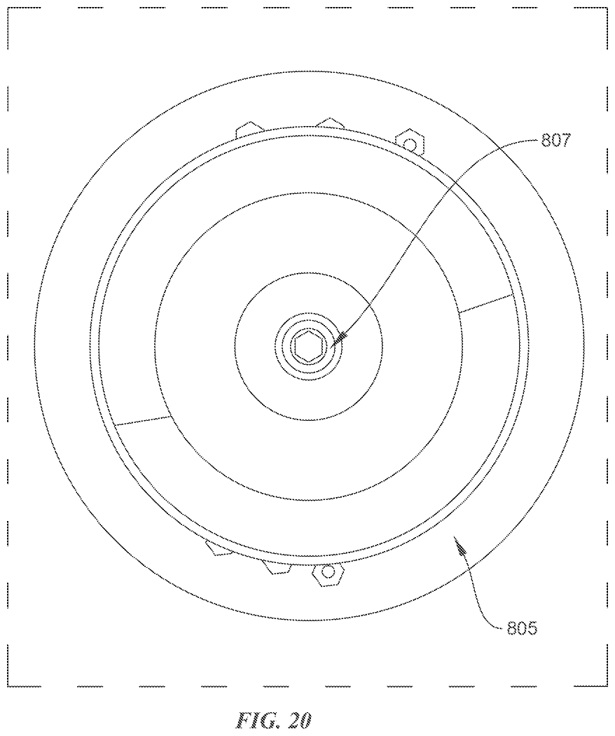

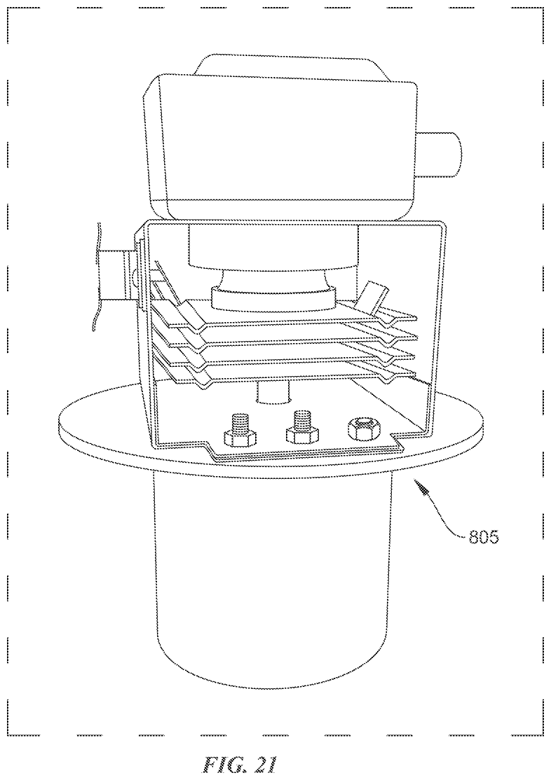

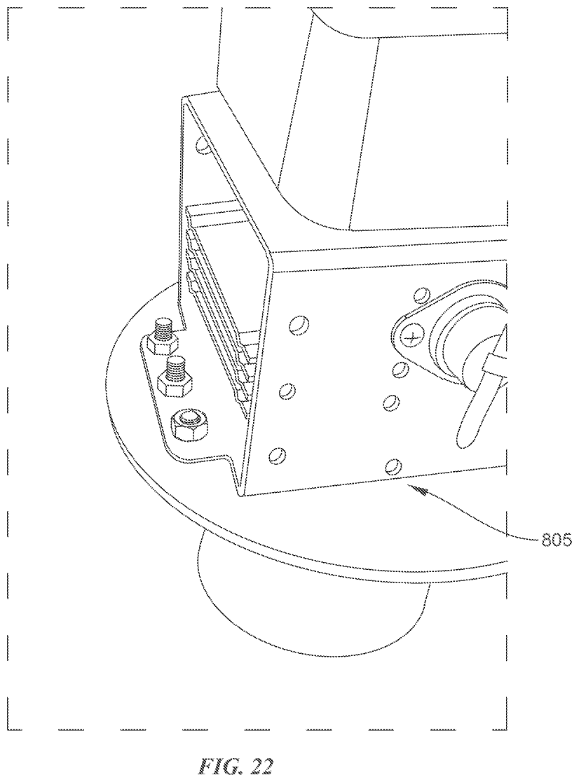

FIGS. 19-22 illustrate views of an example microwave source.

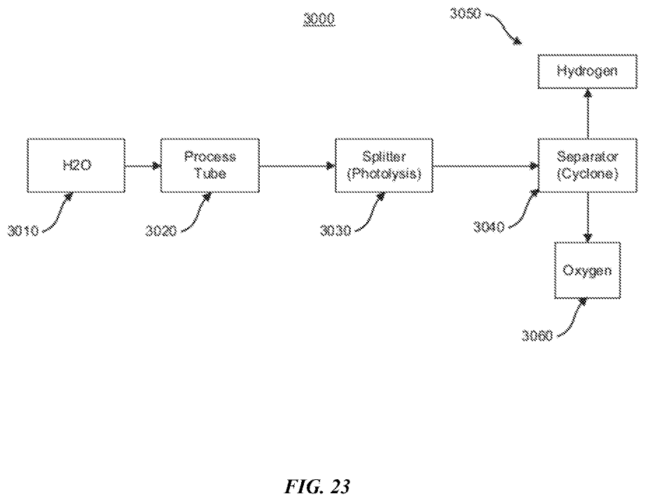

FIG. 23 is a system block diagram illustrating the example processing flow of producing hydrogen from water.

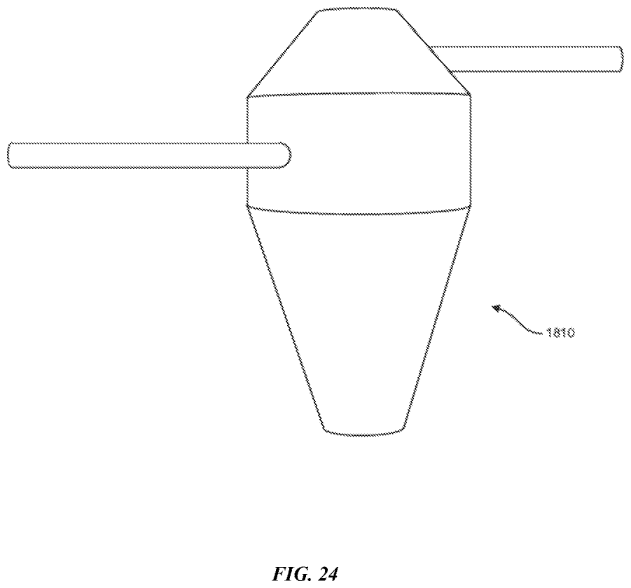

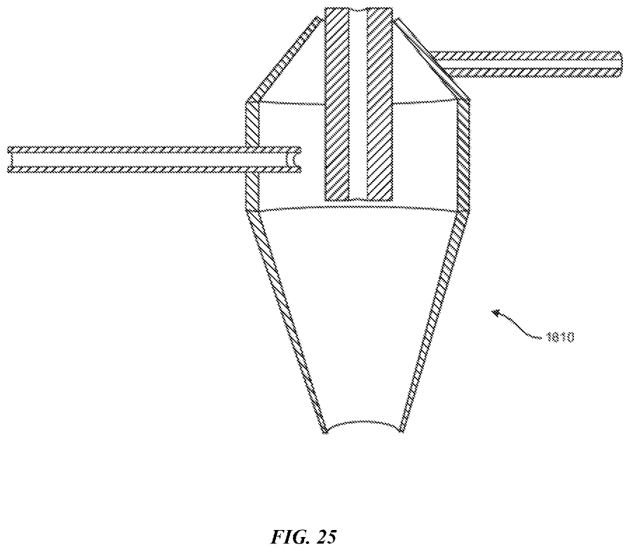

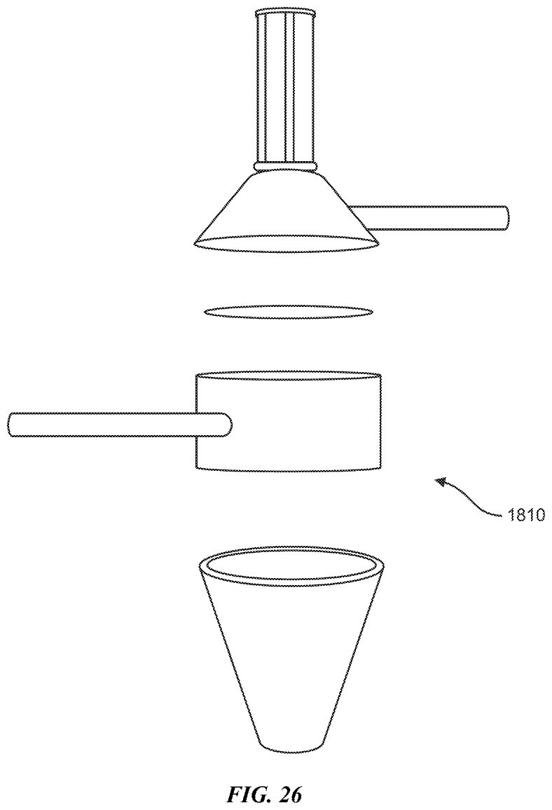

FIGS. 24-26 are views illustrating an example gas separator in the form of a hydrocyclone.

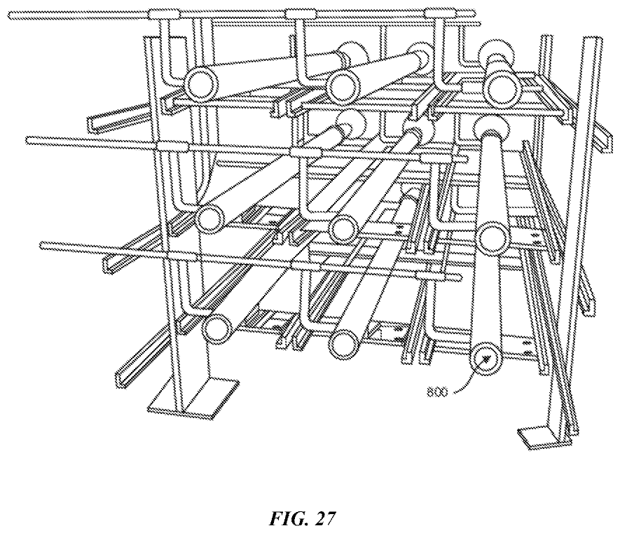

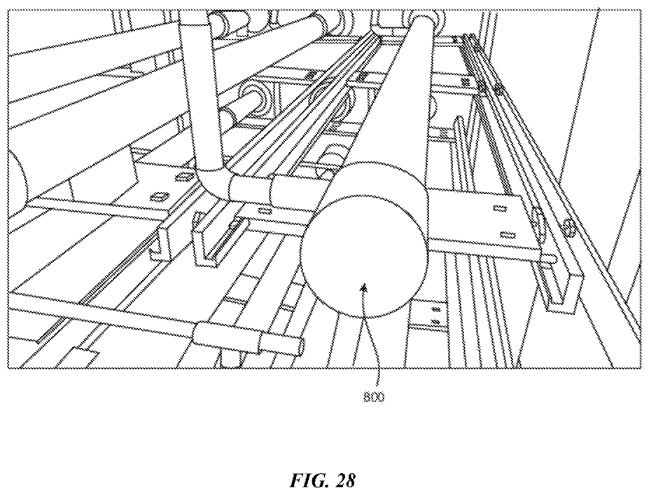

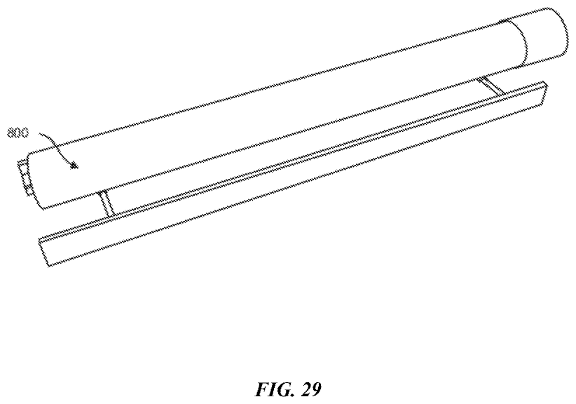

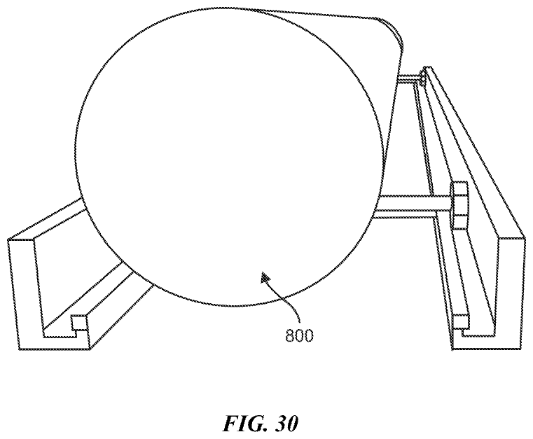

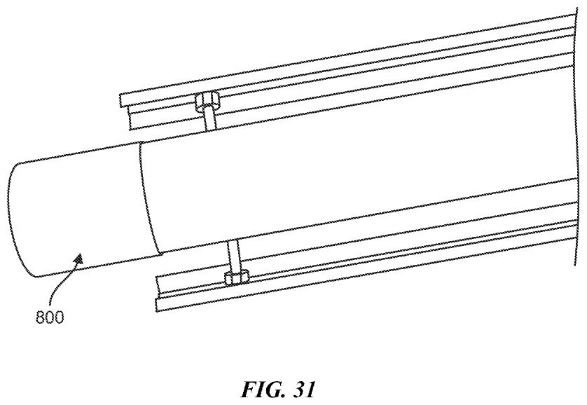

FIGS. 27-32 illustrate various views of an example array of photo-reactors.

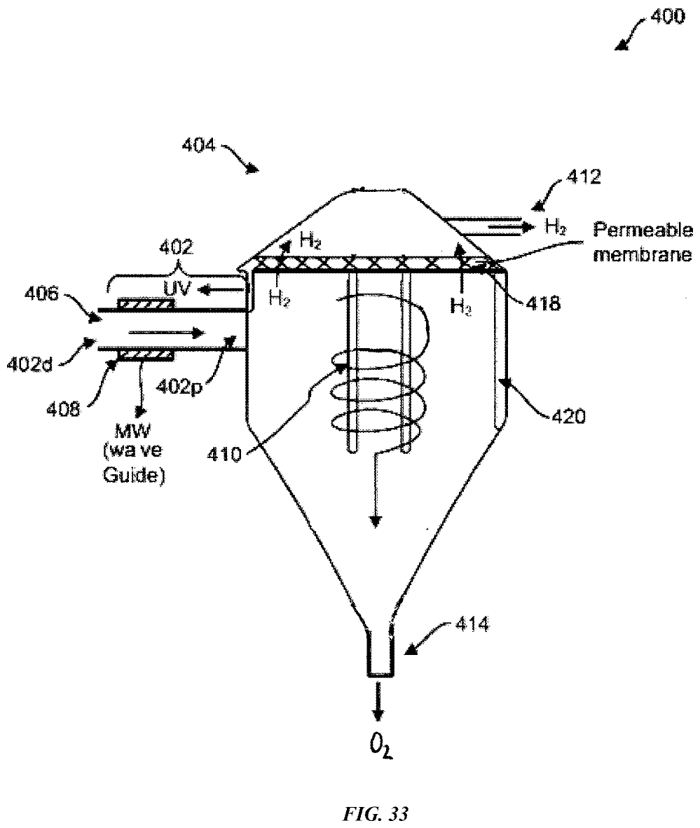

FIG. 33 illustrates an exemplary reactor according to an exemplary embodiment of the present subject matter.

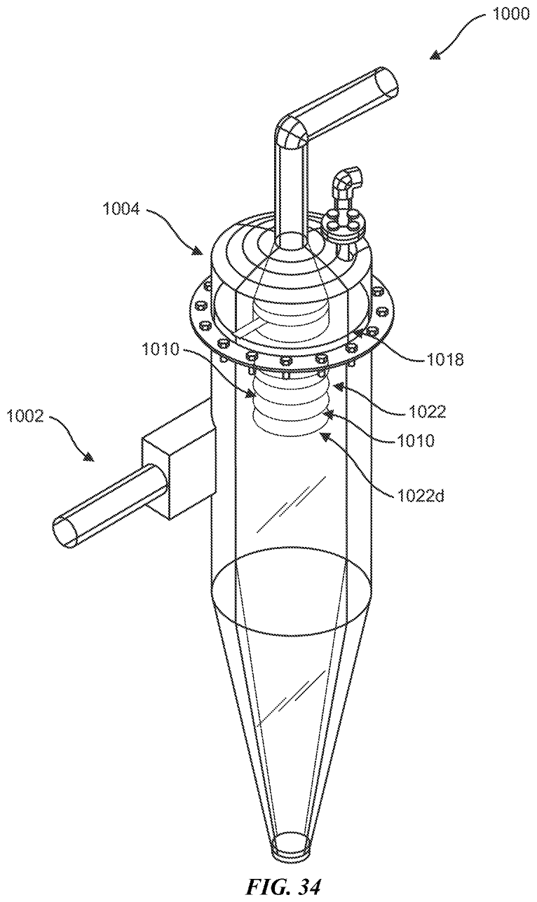

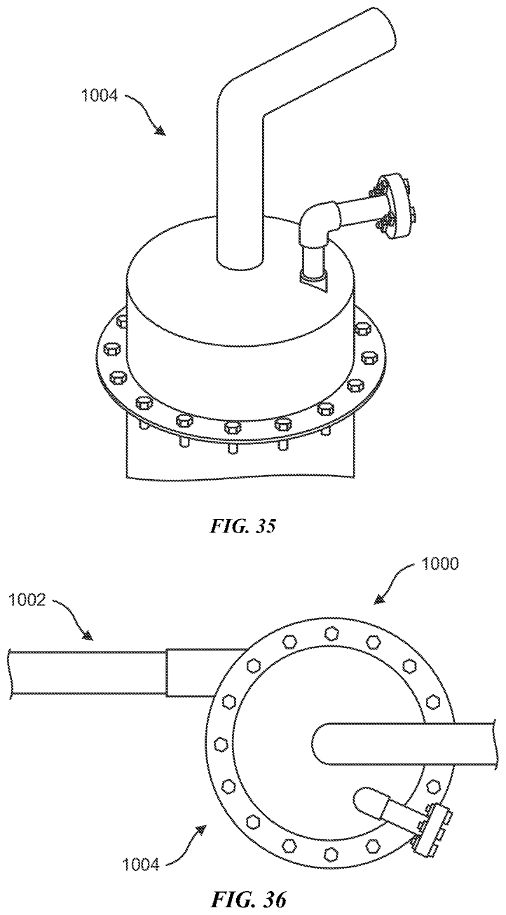

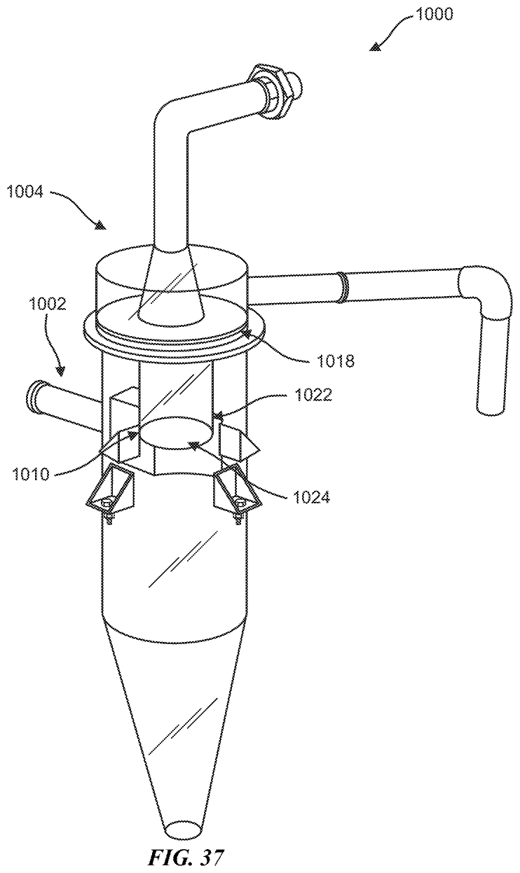

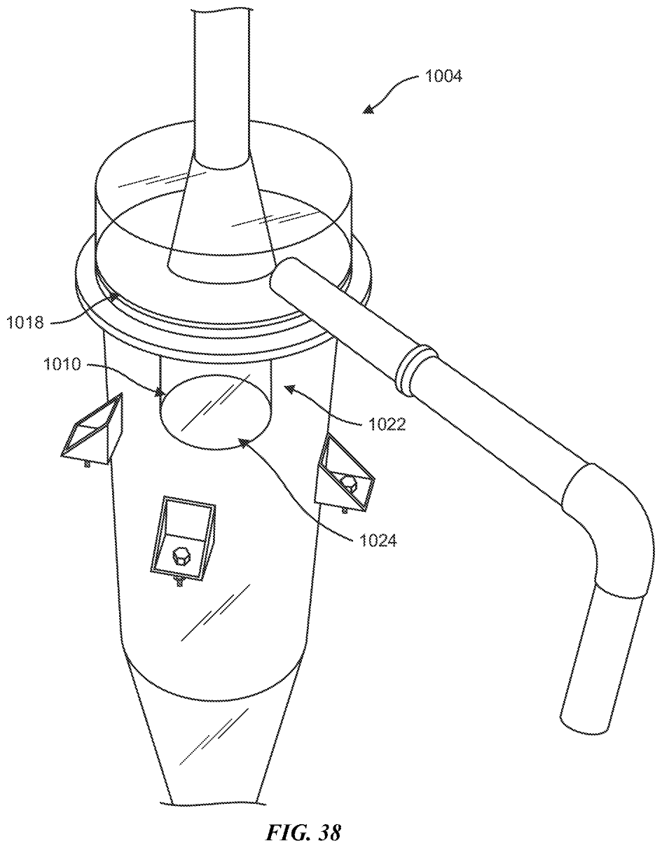

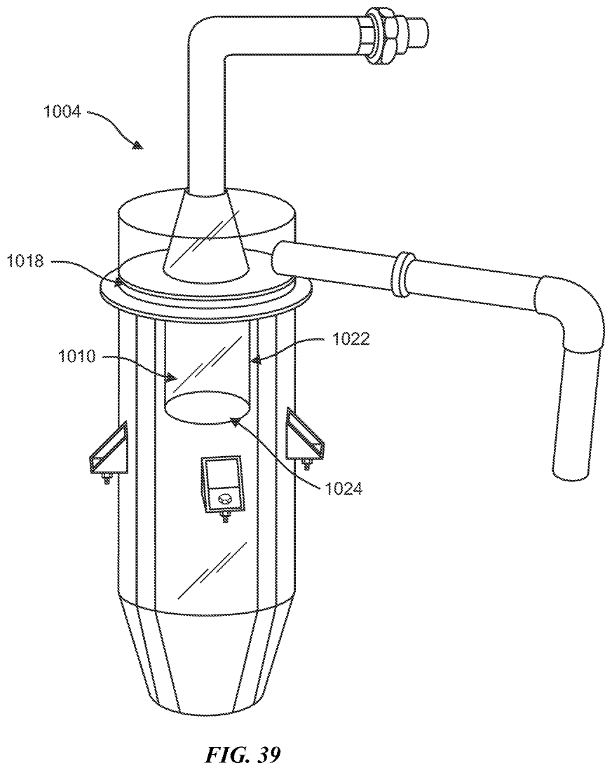

FIGS. 34-40 illustrate various views of exemplary reactors according to exemplary embodiments of the present subject matter.

Like reference symbols in the various drawings indicate like elements.

### DETAILED DESCRIPTION

The term “reactor” as used herein refers to a chamber or vessel where a chemical reaction may occur. The reactor may be provided to maintain a certain volume for the reaction, and further provided with a function to control a temperature and/or a pressure of the reactions.

The term “dissociation” refers to bond breaking between at least two atoms.

The term “bond dissociation energy” refers to an amount of energy required to break a bond between at least two atoms.

The term “radiating” refers to emitting an energy in form of light or heat.

The terminology used herein is for the purpose of describing particular embodiments only and is not intended to limit the subject matter. As used herein, the singular forms “a”, “an” and “the” are intended to include the plural forms as well, unless the context clearly indicates otherwise. It will be further understood that the terms “comprises” and/or “comprising,” or “includes” and/or “including,” when used in this specification, specify the presence of stated features, regions, integers, steps, operations, elements and/or components, but do not preclude the presence or addition of one or more other features, regions, integers, steps, operations, elements, components and/or groups thereof.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Some conventional methods of producing hydrogen can be relatively expensive, energy intensive, and/or produce environmental pollutants (e.g., carbon dioxide). Accordingly, there remains a need for improved systems and methods that address current issues with hydrogen production.

The present subject matter can include systems and methods for producing hydrogen. The hydrogen may be obtained from water (H₂O). In some implementations, the water can be in the form of water vapor (e.g., gas-phase molecules). Vapors are typically colorless (e.g., invisible) and non-wetting but can condense and/or react on contact with liquid and/or solid. In some implementations, the water can be in the form of an aerosol (e.g., a visible aerosol containing water droplets with a size of about 1 nm to 10 μm or greater). In some implementations, the water can be in the form of liquid. In certain implementations, the water is not in liquid form.

In some implementations, hydrogen production from water may be performed by radiating water with microwaves and ultraviolet (UV) light to decompose water into hydrogen and oxygen. The microwaves can serve to thermally excite the water, thereby beneficially causing bond vibration and increasing bond length, and the UV light can cause bond disassociation. The thermal excitation of the water can advantageously increase the ability of the water to absorb the UV light, resulting in greater bond dissociation and consequently, hydrogen production. Furthermore, the thermal excitation of the water can provide the ability to effect bond disassociation using shorter UV wavelengths, which have greater bond penetration power, and therefore, result in a more effective cleaving of the hydrogen bonds that would not otherwise occur with lower UV wavelengths.

Furthermore, in some implementations, the microwaves can form a standing wave, which, due to the polarity of water, can adjust molecular position of the water thereby increasing effective UV absorption area. Increasing effective UV absorption area increases hydrogen production as compared to when a standing wave is not used. For example, the use of a standing wave can expose the bond angles between the hydrogen and oxygen. In some implementations, an electrodeless UV lamp can be used as the UV light source and the UV lamp can be driven by the microwave source that is also radiating the water.

Water may be decomposed into hydrogen gas and oxygen gas using the present system and methods resulting in higher yields, as compared to conventional systems and methods. This is because, as compared to conventional systems and methods, some implementations of the present systems and methods can dissociate O—H bonds at a faster rate, thereby decreasing retention time, and dissociate O—H bonds using smaller amounts of energy. As a result, the formation of other species during bond disassociation can be reduced or minimized.

Water comprises two O—H bonds which can be dissociated upon energy input. The oxygen and hydrogen bonds in water may be broken or dissociated sequentially. For example, as described in reactions (1)-(3), a first bond may be broken when sufficient energy greater than the first bond dissociation energy, e.g., 498.7 KJ/mol at 298K, is applied, and a second may be broken when the energy greater than the second bond dissociation energy, e.g. 428 KJ/mol at 298K, is applied.

| | | | |
|---|---|---|---|
| 2H₂O → 2H₂ (g) + O₂ (g) | | (1) | |
| H₂O → H⁺ + OH⁻ | 498.7 | (2) | first O—H bond breaking |
| | KJ/mol | | (at a temperature of 298 K) |
| O—H → H + O | 428 | (3) | second O—H bond breaking |
| | KJ/mol | | (at a temperature of 298 K) |

Without wishing to be bound to the theory, the first and second dissociation of the O—H bonds may be initiated and performed by supplying sufficient energy to the water reactant molecules. The energy for dissociating O—H bonds of water may be supplied by radiating light. For example, the light radiation may be within ultraviolet (UV) light range, such as UV-C light range. The following Table 1 lists the energy of UV-C light at various wavelengths.

TABLE 1
Exemplary Wavelengths and Associated Energies of UV-C Light

| Wavelength λ (nm) | Energy (kJ) |
|---|---|
| 100 | 1196.66 |
| 110 | 1087.87 |
| 120 | 997.21 |
| 130 | 920.50 |
| 140 | 854.75 |
| 150 | 797.77 |
| 160 | 747.91 |
| 170 | 703.92 |
| 180 | 664.81 |
| 190 | 629.82 |
| 200 | 598.33 |
| 210 | 569.84 |
| 220 | 543.93 |
| 230 | 520.29 |
| 240 | 498.61 |
| 250 | 478.66 |
| 260 | 460.25 |
| 270 | 443.21 |
| 280 | 427.38 |

UV light having sufficient energy to break the first and the second O—H bonds of water may be irradiated for a suitable time, until desired amount or yield of producing hydrogen is obtained. For example, UV radiation of an H₂O molecule may be performed for about 1 μs to 1 second, 1 ms to 1 second, .01 seconds to 15 min, about 1 second to 30 seconds, or about .01 seconds to 15 seconds. It is also contemplated that the UV radiation may be performed for an amount of time that does not fall outside any of these recited ranges.

Further, each dissociation of O—H bonds may be initiated and performed in various temperature ranges. In some implementations, the temperature may range from about 27° C. to 35° C., from about 20° C. to 40° C., or from about 0° C. to 125° C. For example, the bond dissociation energy of water or the activation energy for initiating the reaction may vary in different temperature ranges and the energy required for reactions (1) to (3) may be suitably determined based on reaction temperature. It is also contemplated that the temperature does not fall outside any of these recited ranges.

In some implementations, the water may be supplied to the system in the form of a vapor. In some implementations, the system may include a vapor producing subsystem such that water in a liquid form can be initially introduced into the system and subsequently heated to a vapor. Once the water is heated to a vapor, the resulting water vapor can then be exposed to microwaves and UV light such that the water vapor is broken down into hydrogen and oxygen.

In some implementations, the water may be supplied to the system in the form of an aerosol. In some implementations, the system may include an aerosol producing subsystem such that water in a liquid form can be initially introduced into the system. Once the water is heated to an aerosol, the water vapor is then exposed to microwaves and UV light such that the water vapor is broken down into hydrogen and oxygen.

In some implementations, the water may be supplied to the system in a liquid form.

The present subject matter can include a method of producing hydrogen. The method can include providing water into a reactor and decomposing the water. In some implementations, the present reactors described herein can be designed as self-extinguishing to thereby prevent a combustible event from occurring (e.g., a reactor explosion) during hydrogen production.

The water may be supplied continuously. In some implementations, the water may be supplied or provided to maintain the partial pressure thereof in the reactor of about 0.1 atm to 10 atm, of about 0.1 atm to 1 atm, or of about 0.1 atm to 0.5 atm. It is also contemplated that the pressure does not fall outside any of these recited ranges.

Alternatively, the initial pressure of the water in the reactor may be of about 0.1 atm to 10 atm, of about 0.1 atm to 1 atm, of about 0.1 atm to 0.5 atm. It is also contemplated that the initial pressure does not fall outside any of these recited ranges. It is further contemplated that the initial pressure can be between any of these recited values.

The reactor may have a temperature range of about 27° C. to 35° C., from 20° C. to 40° C., or from about 0° C. to about 125° C., or alternatively, the decomposition of the water may be performed at a temperature range of 27° C. to 35° C., from 20° C. to 40° C., or from about 0° C. to about 125° C. For example, the reactor may be heated using flame, electric furnace, air stream or the like. In some implementations, the decomposition of the water may be performed at about ambient temperature. In some implementations, the decomposition of the water may be performed at a temperature of at least 100° C. It is also contemplated that the temperature does not fall outside any of these recited ranges. In other embodiments, the temperature may be between any of these recited values.

Energy can be supplied to decompose the water in the reactor. The energy source for decomposition or dissociating the water may be UV light. The UV light may have a wavelength ranging from about 91 nm to 400 nm, about 100 nm to about 280 nm, from about 100 nm to about 200 nm, from about 150 nm to about 190 nm. In some implementations, the UV light can have a wavelength of 185 nm. In some implementations, the wavelength of the UV light can depend at least upon the form of water. As such, other suitable wavelengths of UV light can be used within the system. Further, in some implementations, the energy associated with the wavelength(s) of the UV light for dissociating the water can be high enough so as to decompose other compounds that may be present within the reactor. For example, in some implementations, when ambient air is present within the reactor (e.g., as being a component of the input feed), the energy applied via the UV light can be sufficient to breakdown not only the water, but also other compounds present within the air as well as prevent bonds from forming or reforming between the broken down components. As a result, the formation of reactive species (e.g., NO_{X}, SO_{X}, CO_{X}, and the like) can be avoided, and thus, the efficacy of the hydrogen production can be increased. UV light may be radiated for about 0.01 seconds to 15 min, about 1 second to 30 seconds, or about 0.01 seconds to 15 seconds. It is also contemplated that the UV light may be radiated for a period of time that does not fall outside any of these recited time ranges. It is further contemplated that the UV light may be radiated for a period of time between any of these recited values.

FIG. 1 is a longitudinal cross section of an example photo-reactor 800 for decomposing water into hydrogen gas and oxygen gas. The photo-reactor 800 can be coupled to a water source (e.g., in a hydrocarbon processing facility) and/or coupled to a gas separator to separate the hydrogen gas from the oxygen gas. The photo-reactor 800 can include a microwave source 805, a first chamber 810, a second chamber 815, and an optional third chamber 835. The photo-reactor 800 can be formed in a generally cylindrical shape (e.g., a tube).

The first chamber 810 can include an inlet 812 for receiving an input stream including water. In certain implementations, the water can be in the form of vapor, whereas in other implementations the water can be in the form of an aerosol. The first chamber 810 can be adjacent to the second chamber 815 and the input stream can include water and can flow from the first chamber 810 into the second chamber 815 through an opening 814. The first chamber 810 can be formed of a suitable material such as stainless steel.

The second chamber 815 can be elongate and cylindrical along a primary axis. The second chamber 815 can include a waveguide 820, which, in the illustrated example, is formed by a wall of the second chamber 815. The second chamber 815 is thus formed of a suitably conductive material such as stainless steel. In some implementations, the waveguide 820 may be formed by another structure. The waveguide 820 includes a first waveguide end 822 at an end of the second chamber 815 that is non-adjacent the first chamber 810, and a second waveguide end 824 that is adjacent the first chamber 810. As illustrated in FIG. 1, the first waveguide end 822 is integral with an end of the second chamber 815. The second chamber 815 can include an outlet 826 that is non-adjacent the first chamber 810.

A tube assembly 830 can reside within the second chamber 815 and can extend along a primary axis of the second chamber 815. An ultraviolet light source 825 can also reside within the tube assembly 830. In addition the ultraviolet light source 825, a negative electrode 827 and a positive electrode 829 can reside within the tube assembly 830. The negative electrode 827 and the positive electrode 829 can be external to the ultraviolet light source 825 and internal to the waveguide 820. The negative electrode 827 and positive electrode 829 can be plate shaped. The negative electrode 827 can be located or arranged above the ultraviolet light source 825 and the positive electrode 829 can be located or arranged below the ultraviolet light source 825. FIG. 2 is a cross-sectional view of the tube assembly 830. The cross-sectional view illustrated in FIG. 2 is perpendicular to the cross-sectional view of FIG. 1.

In other embodiments, in addition to the ultraviolet light source 825, a proton exchange membrane can reside within the tube assembly 830.

In some implementations, a wall 832 of the tube assembly 830 is transparent to both ultraviolet light and microwave energy. The wall 832 may be formed of a suitably transparent material such as quartz. In some implementations, the wall 832 extends from an inner surface to the waveguide 820. The quartz or other suitably appropriate material (e.g., glass) can provide structural support as well as be transparent to ultraviolet light and microwave energy.

The ultraviolet light source 825 can include an electrodeless lamp, which can include a gas discharge lamp in which the power required to generate light is transferred from outside the lamp to gas inside via an electric or magnetic field. This is in contrast with a gas discharge lamp that uses internal electrodes connected to a power supply by conductors that pass through the lamp. There can be a number of advantages to an electrodeless lamp, including extending lamp life because electrodes can fail, and power savings because internal gases that are higher efficiency can be used that would react if in contact with an electrode.

Further, the use of an electrodeless lamp, as opposed to plasma, in the systems and method presented herein can have advantages. For example, compared to plasma, one advantage to using the electrodeless lamp is the cost-savings because plasma is highly dependent on, and therefore consumes a substantial amount of, electricity. Another advantage can include the extended lifetime of the electrodeless lamp relative to plasma. Unfortunately, due to high temperatures that can be generated by the plasma arc, decreased arc mobility, and the like, the electrodes can prematurely fail or erode during use, thereby decreasing electrode lifetime. Moreover, using plasma as a radiation source can have its own drawbacks, such as ignition, sustainability, and confinement.

The ultraviolet light source 825 can generate light within a range of wavelengths, for example, between 100 nm and 300 nm, between 150 nm and 200 nm, between 180 nm to 190 nm, and the like. The gas contained in the lamp can include: argon, mercury, and iodine. In some implementations, the lamp can include argon at 25 KPa and 20 mg of mercury. Other gases, amounts, and pressures are possible.

The second chamber 815, ultraviolet light source 825, negative electrode 827, and positive electrode 829 can be elongate and extend along the primary axis of the second chamber 815.

The optional third chamber 835 can be adjacent the second chamber 815 and can include two outlets (first outlet 837 and second outlet 839). The third chamber 835 can serve as an initial separation space for extracting hydrogen gas through the first outlet 837 and oxygen gas and any other materials present through the second outlet 839. In some implementations, the third chamber 835 can include a gas separator such as a cyclone and need not be integral with the second chamber 815.

The microwave source 805 can be adjacent to the first chamber 810 and can include an emitter 807 for radiating microwave energy. The microwave source 805 can emit electromagnetic energy at frequencies between 200 MHz and 300 GHz (corresponding wavelengths between 100 cm and 0.1 cm). In some implementations, the microwave source 805 emits electromagnetic energy at frequencies between about 900 MHz and 2.45 GHz. In some implementations, the microwave source 805 emits electromagnetic energy at a frequency of about 2.45 GHz. It is also contemplated that the present microwave source can emit microwaves at a frequency between any of these recited values.

The microwave source 805 can be arranged to radiate microwave energy into the first chamber 810 and the waveguide 820 of the second chamber 815 and to contact the ultraviolet light source 825. When the microwave energy contacts the ultraviolet light source 825, the ultraviolet light source 825 can generate ultraviolet light. In some implementations, the microwave source 805 can be arranged to radiate microwave energy so that the microwave energy passes through the first chamber 810 to reach the second chamber 815. The microwave energy produced by the microwave source 805 can thermally excite water residing within the first chamber 810 and simultaneously drive/excite the ultraviolet light source 825. Such an arrangement can be efficient in that little radiated energy is lost because it can serve to both thermally excite the water and generate the ultraviolet light, both of which contribute to bond disassociation (e.g., creating hydrogen gas and oxygen has from water). Moreover, this arrangement can enable tuning of the microwave source such that only the amount of energy needed for bond disassociated is input to the system with little energy wasted to unnecessary thermal heating.

First waveguide end 822 and second waveguide end 824 can be formed such that the second chamber 815 and/or waveguide 820 serves as a resonator because microwave energy radiated into the second chamber 815 is reflected. This arrangement can result in the formation of a standing wave within the second chamber as a result of interference between waves reflected back and forth within the second chamber 815 and/or waveguide 820. A standing wave (also referred to as a stationary wave) can include a wave in which each point on the axis of the wave has an associated constant amplitude. For example, FIG. 3 illustrates the photo-reactor 800 of FIG. 1 with a standing wave 1005 illustrated. Locations at which the amplitude is minimum are called nodes and locations where the amplitude is maximum are called antinodes. The photo-reactor 800 can be designed and/or controlled such that positive amplitude values of the standing wave are positioned on the positive electrode 829 and negative amplitude values of the standing wave are positioned on the negative electrode 827.

In operation, a flow of water gas is introduced into inlet 812 under a pressure and a temperature. The water gas is contacted with microwave energy in the form of microwaves radiated by the microwave source 805. When contacted with microwave energy, the water is thermally excited. The thermally excited water flows into the second chamber 815 including into the interior of the tube assembly 830. The thermally excited water is contacted with the standing wave. Because water is polar in that the molecule has an uneven distribution of electrons, the molecule has a positively charged side and a negatively charged side. The water in the presence of the standing wave will align (e.g., orient) itself with the standing wave. This will increase the molecule's effective cross-sectional area for ultraviolet light absorption. As a result, water exposed to a standing wave and ultraviolet light will absorb more energy from the ultraviolet light than water that is not in the presence of a standing wave.

The thermally excited water exposed to ultraviolet light can result in bond disassociations and the creation of hydrogen ions (H⁺) and oxygen ions (O²⁻). The hydrogen can be attracted to the negative electrode 827 and the oxygen can be attracted to the positive electrode 829. This can cause the hydrogen and oxygen to physically separate, which reduces the amount and likelihood that these radicals will react to form water. This can act as a form of quenching (e.g., stopping or reducing the reverse reaction). The negative electrode 827 can be arranged above the positive electrode 829 because the hydrogen is lighter than the oxygen (thus the oxygen will be pulled downwards by gravity). Alternatively, the positive and negative electrodes 827, 829 can be replaced with a proton exchange membrane, which can act as a form of quenching.

The resident time of the water within the second chamber 815 can be controlled by controlling the length of the second chamber 815 and the flow rate of the water into the photo-reactor 800. In addition, the energy imparted by the microwave source 805 and the ultraviolet light source 825 to the water can affect the required resident time.

The hydrogen and oxygen can exit the second chamber 815 through the second chamber outlet 823. In implementations where the third chamber 835 is included hydrogen, being lighter, can exit through the first outlet 837 while oxygen, being heavier, can exit through the second outlet 839. In implementations where the third chamber 835 is not includes, a gas separator such as a cyclone can be coupled to the system and in fluid communication with the second chamber outlet, such that the hydrogen gas can be separated from the oxygen gas.

While the above example operation has been described with pure water provided as input to the photo-reactor 800, contaminants can also be included. Common contaminants can include carbon dioxide, methane, and other hydrocarbons. These contaminants can exit the photo-reactor 800, e.g., through the second outlet 839 along with the oxygen. By reducing the amount of contaminants in the water, energy efficiency in the system is improved because more energy is consumed when the contaminants are exposed to the microwave energy and ultraviolet light.

In addition, the frequencies/wavelengths of ultraviolet light generated by the ultraviolet light source 825 can be varied by controlling and/or modifying the microwave source 805. By changing the frequency/wavelength of the microwave energy, the frequency of the light generated by the ultraviolet light source 825 can change. Changing the frequency/wavelength of the ultraviolet light can enable an operator to tune the photo-reactor 800 based on the expected contaminants in the input stream to improve efficiency. The ultraviolet light frequencies/wavelengths can be tuned to frequencies/wavelengths where the water has a higher absorption coefficient and the contaminants have a lower absorption coefficient. Thus, some implementations of the photo-reactor 800 need not be redesigned for each application.

Some implementations can include multiple tube assemblies 830 arranged in parallel. For example, FIG. 4 is a cross-sectional view of another example second chamber 815 having multiple tube assemblies 830. The cross-sectional view illustrated in FIG. 4 is perpendicular to the cross-sectional view of FIG. 1. The tube assemblies 830 are arranged within the second chamber 815 and each can have its own ultraviolet light source 825, negative electrode 827 and positive electrode 829. A region 1105 between the tube assemblies can be formed of a material that is transparent to both ultraviolet light and microwave energy, such as quartz. The arrangement of FIG. 4 allows for light emitted from one ultraviolet light source 825 to not only illuminate water within its tube assembly 830 but to also illuminate water within the other tube assemblies 830. The multiple ultraviolet light sources 825 can be excited/driven by a common microwave source 805 and reside within a common waveguide. In some implementations, each tube assembly 830 includes a respective waveguide 820.

FIGS. 5-10 are views of an example photo-reactor 800 according to some implementations of the current subject matter.

FIG. 11 illustrates an example system 1800 for decomposing water. The system 1800 includes a photo-reactor 800, water source 1805, and gas separator 1810. FIGS. 12-18 illustrate various views of the example system 1800.

FIGS. 19-22 illustrate views of an example microwave source 805. In the illustrated example, the microwave source 805 is a magnetron.

FIG. 23 is a system block diagram illustrating the example processing flow 3000 of producing hydrogen from water. At 3010, water is provided. At 320, the water is present in a process tube (e.g., first chamber 810). At 3030, the water is split using photolysis (e.g., in a second chamber 815). At 3040, a separator (e.g., a cyclone) 3040 separates the split water into hydrogen gas 3050 and oxygen gas 3060.

FIGS. 24-26 are views illustrating an example gas separator 1810 in the form of a cyclone. In some implementations, the gas separator can include an internal lining. For example, at least a portion of the internal surface of the gas separator can be coated with one or more of anti-corrosive materials. In this way, for example, rust that would otherwise form on the interior surface of the gas separator can be minimized or prevented.

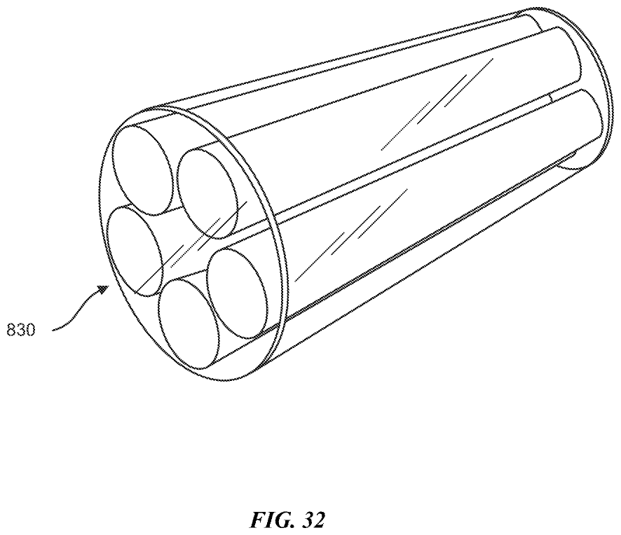

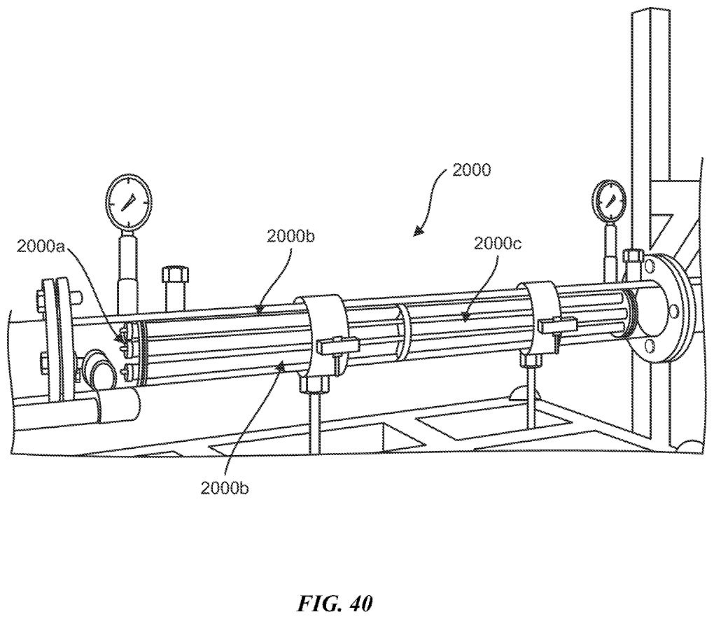

In some implementations, an array of photo-reactors can be used in parallel to scale any process. For example, FIGS. 27-32 illustrate various views of an example array of photo-reactors. Each photo-reactor includes a chamber through which the water can pass. Within the chamber is at least one ultraviolet light source for irradiating the water and decomposing the water into hydrogen and oxygen. In FIG. 27, the array of reactors includes 9 reactors (3×3 array) that can divide an input stream into 9 separate streams and process each stream independently and in parallel. The 9 output streams can be recombined for further processing or can be maintained as separate streams. Other implementations are possible, for example, FIG. 32 illustrates a 5 ultraviolet light chamber. Another exemplary array of photo-reactors is shown in FIG. 40 in which the array of photo-reactors 2000 includes 4 photo-reactors 2000a, 2000b, 2000c, and 2000d.

Another example system or apparatus according to the current subject matter can include an electronic module, lamp module, microwave module, reactor module, sensor module, extraction module, mounting structure, pipes/fittings, control module, blower module, separator/recovery module, and a safety module. The electronic module can include a microcontroller and a power controller. The lamp module can include an electrode less lamp and a lamp mounting. The microwave module can include a magnetron, power unit, and a wave guide. The reactor module can include a continuously stirred reactor (CSTR), mounting, sensor's ports (thermal, pressure, flow, UV, H₂ sensor, H₂O sensor, multi-gas sensors, and the like), and wiring harnesses/conduits. The sensor module can include temperature, pressure, UV, flow, valve/actuator position, and gas sensors (H₂, CH₄, CO₂ and the like). The extraction module can include a cyclone, cooling coil, thermoelectric coolers, electrodes (e.g., plates) for recovering radicals, and gate/valve actuator. The mounting structure can include a tube, cyclone, microwave module, sensor module, electronic module, frame and (angles, channels, beams, and the like). Piping and fittings can include pipes, elbows, reducers, tees, plugs, and valves. Command and control module can include a computer and data acquisition board. Safety module can include safety (pressure) relief system, hydrogen control system, environmental monitoring system, and accidental UV exposure protection system. Blower module can include type: centrifugal; screw and the like; capacity (size): flow rates in CFM, discharge pressures, and controls. Separators and recovery module can include CO₂ liquefaction system for recovering CO₂ and other gases from the feed, hydrogen processing system, oxygen processing system, and CO₂ processing system.

In some embodiments, the present systems can include at least two chambers coupled and in fluid communication therewith. The first chamber can be configured to receive and thermally excite an input feed that includes at least a portion of water. The second chamber can be configured to receive the thermally excited feed, to decompose the water within the feed such that hydrogen and oxygen gas result, and to separate the hydrogen and oxygen gas as well as any other components that may be present in the input feed.

As discussed in more detail below, the first chamber can include a microwave source that can be configured to expose the input feed that is flowing in and through the first chamber to microwave energy. This exposure can increase ability of the water to absorb energy, such as UV light, which can enhance the effectiveness of the photolytic breakdown of water. Further, in some embodiments, the first chamber can be configured to facilitate the formation of a standing wave, which as discussed above, allows the water to align itself, thereby increasing its effective cross-sectional area for UV light absorption.

Further, as discussed in more detail below, the second chamber can include a light source, such as a UV light source, that is configured to expose the thermally excited feed to an effective amount of electromagnetic energy that can result in cleavage of the hydrogen-oxygen bonds, and thus the formation of hydrogen and oxygen gas. While the second chamber can be coupled to a separator to isolate the oxygen gas, in some implementations, the second chamber can be configured to isolate the oxygen gas from the remaining feed components present within the second chamber. The second chamber can also be configured to separate the cleaved hydrogen from the remaining feed components.

FIG. 33 illustrates an exemplary embodiment of a hydrogen production system 400. As shown, the system 400 includes two chambers 402, 404 coupled together and in fluid communication. The first chamber 402 includes an inlet 406 that receives an input feed (not shown). The input feed can be raw or processed feed having a compositional makeup that includes at least water. In some implementations, the input feed can be in the form of a vapor, in the form of aerosol, or can contain both vapor and aerosol. In some implementations, the system 400 can include a vapor and/or aerosol producing subsystem upstream of the inlet 406.

The inlet 406 can supply the input feed at a constant flow rate, which can vary depending on the implementation of the system. The inlet 406 can include a gauge or valve to control the flow rate of the input feed. Alternatively, the flow rate of the input feed can be continuously changed, for example, to decrease, increase, or maintain product yield (e.g., oxygen gas).

The first chamber 402 can also include a microwave source 408 that is positioned proximate to the inlet 406 (e.g., at a distal end 402d of the first chamber 402). The microwave source 408 emits microwave energy so as to thermally excite the water present in the input feed as it flows into and through the first chamber 402. As shown, the first chamber 402 can be elongate and cylindrical along a primary axis (e.g., a tube-like configuration). It is also contemplated herein that the first chamber 402 can have other configurations. Further, it is also contemplated that the first chamber 402 can be a photo-reactor similar to photo reactor 800 shown in FIG. 1 or an array of photo-reactors similar to array 2000 shown in FIG. 40.

The first chamber 402 can include a waveguide that is configured to guide the microwave energy through the first chamber (e.g., from the distal end 402d to the proximate end 402p of the first chamber 402 in which the proximate end 404p). In some embodiments, the waveguide can be formed by a wall of the first chamber 402. In such instances, the first chamber 402 can be formed of a suitably reflective material such as stainless steel. Further, at least a portion of the inner surface of the wall can be coated with a composition in desired areas for reflection. Alternatively, or in addition to, the first chamber 402 can include a separate waveguide (e.g., a waveguide that is not formed by the wall of the first chamber).

It should be noted that in some embodiments, the first chamber can include an array of sub-chambers that are structured similar to first chamber 402 as shown in FIG. 33. The sub-chambers can be arranged in series or in parallel.

As shown in FIG. 33, the proximal end 402p of the first chamber 402 couples to the second chamber 404. The second chamber 404 includes a light source 410. As such, the second chamber 404 can function as a photo-reactor. While the light source 410 can be configured to emit various types of light, in some implementations, the light source 410 emits UV light. In some implementations, the light source 410 radiates UV light having a wavelength ranging from about 100 nm to about 280 nm, from about 100 nm to about 200 nm, from about 150 nm to about 190 nm. In one implementation, the light source 410 radiates UV light having a wavelength of 185 nm. As shown, the light source 410 can be attached to at least a portion of the inner surface of the second chamber 404. In one embodiment, the light source 410 can be coupled to the entire inner surface. It is contemplated herein that the light source 410 can be positioned at other areas or coupled to a component of the second chamber 404, such as about a vortex finder 1022 in FIG. 34 as described in more detail below.

The radiation time and/or the intensity of light emitted within the second chamber 404 can be suitably adjusted by modifying the parameters of the light source 410. The light source 410 can be suitably selected from a radiating device that can intensify a particular range of wavelengths. An exemplary light source may include an electrodeless lamp. The electrodeless lamp can include a gas discharge lamp. The gas contained in the lamp can include argon, mercury, and iodine.

In use, as the input feed flows from the first chamber 402 and into the second chamber 404, the UV light emitted by the light source 410 is at least partially absorbed by the water. As a result, bond disassociate occurs, thereby producing hydrogen gas and oxygen gas. While the second chamber 404 can have various shapes, the second chamber 404, as shown in FIG. 33, takes the form of a cyclone, and therefore, the resulting hydrogen gas is ventilated from the second chamber 404 through a first outlet 412 positioned at a top portion thereof. Further, the resulting oxygen gas, which is heavier than hydrogen gas, is ventilated from the second chamber 404 through a second outlet 414 positioned at a bottom portion thereof. In addition, the remaining components of the feed present within the second chamber 404 can ventilate with the hydrogen gas through the first outlet 412 or with the oxygen gas through second outlet 414. Alternatively, or in addition to, the remaining components (e.g., gas impurities) can ventilate from the second chamber 404 through a third outlet (not shown). Any outlet of the second chamber 404 can include a gauge or valve to control the exit rate of the respective component(s).

While not shown, in some implementations, the second outlet 414 can be coupled to a downstream oxygen gas purification sub-system that is configured to remove one or more selected contaminants and/or the remaining components of the feed from the oxygen gas. The oxygen gas purification can be carried out using any one or more suitable filtration methods configured to remove the one or more selected contaminants and/or the remaining components of the feed as necessary.

Further, as shown in FIG. 33, the second chamber 404 can include a permeable membrane 418 (e.g., a proton exchange membrane such as a Nafion™ membrane) that can be configured to separate the hydrogen gas from the remaining components of the feed and/or the oxygen gas. As shown, the permeable membrane 418 substantially separates the hydrogen gas such that the hydrogen gas can ventilate through the first outlet 412. Further, in some implementations where a reactant gas is present within the second chamber 404, the permeable membrane 418 can also be configured to separate the hydrogen gas from the reactant gas. In some embodiments, the permeable membrane 418 can include a catalyst.

As shown in FIG. 33, the second chamber 404 can include a cooling element 420. The cooling element 420 can be configured to control or change the temperature of the oxygen gas, for example, decrease the temperature to thereby particulate the oxygen gas. As shown, the cooling element 420 can be can be coupled to the inner surface of the second chamber 404. In other embodiments, the cooling element 420 can be incorporated within, or coupled to the outer surface of, the wall of the second chamber 404 so as to form a jacketed second chamber. In another embodiment, the second chamber can be connected to a cooling device (e.g., heat exchanger). Non-limiting examples of suitable cooling elements include air, water, and the like of suitable temperature.

Further, the second chamber 404 can include or be connected to a heating device. The heating device can be configured to control the reaction temperature at the beginning of the decomposing reaction or during the decomposing reaction. Non-limiting examples of suitable heating devices include a flame, an electric furnace, a hot plate, and an air stream. Alternatively, or in addition to, a heating element can be incorporated within, or coupled to the outer surface of, a wall of the second chamber 404. Examples of suitable heating elements include air, water, and the like of suitable temperature.

While not shown, the second chamber 404 can include an internal lining. For example, at least a portion of the internal surface of the second chamber 404 can be coated with one or more of anti-corrosive materials. In this way, for example, rust that would otherwise form on the interior surface of the second chamber 404 can be minimized or prevented.

In some embodiments, the system 400 can include a controller or can be in wired or wireless communication with a controller. The controller refers to a hardware device that may include a memory and a processor. The memory is configured to store the modules and the processor is specifically configured to execute said modules to perform one or more processes. The control logic of the present subject matter may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN). The controller can be suitably connected to at least one component of the system, for example, the inlet, the outlets, the first chamber, the second chamber, the microwave source, and the light source, and control the reaction (decomposition condition). The controller may have a controlling algorithm that can suitably adjust conditions of the system.

FIGS. 34-39 illustrate another exemplary embodiment of a system 1000 for producing hydrogen from water. Aside from the differences described in detail below, the system 1000 can be similar to system 400 shown in FIG. 1 and is therefore not described in detail herein. Further, for purposes of simplicity, certain components of the system 1000 are not illustrated in FIGS. 34-39.

As shown in FIGS. 34 and 36-37, the system 1000 includes a first chamber 1002 and a second chamber 1004 coupled thereto. The first chamber 1002 can be a photo-reactor, like photo-reactor 800 shown in FIG. 1, or an array of photo-reactors, like array 2000 shown in FIG. 40. In some embodiments, the first chamber 1002 is directly coupled to the second chamber, as shown in FIGS. 34 and 36-37. In other embodiments, additional chambers or other components could be positioned between the first and second chambers 1002, 1004.

As shown in FIG. 34, the second chamber can include a light source 1010 positioned about a vortex finder 1022 in the second chamber 1004. While the light source 1010 can have a variety of configurations, as shown in FIGS. 34 and 37-39, the light source 1010 has a helical configuration that is wrapped about the outer surface of the vortex finder 1022. In use, a microwave source (not shown) can radiate the microwave energy into the second chamber 1004 such that the microwave energy contacts the light source 1010. In some embodiments, the light source 1010 can include an internal gas that generates ultraviolet light upon contact with the microwave energy.

Further, as shown in FIGS. 34 and 37-39, the second chamber 1004 includes two gas permeable membranes 1018, like gas permeable membrane 418 shown in FIG. 1, and a second gas permeable membrane 1024. The second gas permeable membrane is positioned at the distal end 1022d of the vortex finder 1022. The second gas permeable membrane 1024 (e.g., a proton exchange membrane) can be configured similar to gas permeable membrane 418 and therefore is not discussed in detail herein.

Although a few variations have been described in detail above, other modifications or additions are possible. For example, an ultraviolet light reactor can be used for disinfection, for cleaving bonds of material other than water (e.g., other binary and tertiary molecules with appropriate bond disassociation energies).

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

1. A system comprising:
a first chamber including an inlet that allows an input feed to enter the first chamber, the input feed comprising water;
a microwave source configured to radiate microwave energy into at least the first chamber;
a second chamber in communication with the first chamber, the second chamber including an outlet and a waveguide; and
an ultraviolet light source residing within the waveguide of the second chamber, the ultraviolet light source being configured to emit ultraviolet light to at least partially breakdown the water into hydrogen gas and oxygen gas as the water flows through the second chamber.

2. The system of claim 1, wherein the water is in the form of a vapor, or wherein the water is in the form of an aerosol.

3. (canceled).

4. The system of claim 1, wherein the microwave source is further configured to radiate the microwave energy into the waveguide of the second chamber such that the microwave energy contacts the ultraviolet light source, and wherein the ultraviolet light source includes an internal gas that generates the ultraviolet light upon contact with the microwave energy.

5. (canceled).

6. The system of claim 1, wherein the second chamber further includes:
a first electrode configured to have a negative charge; and
a second electrode configured to have a positive charge, the first electrode and the second electrode being external to the ultraviolet light source and internal to the waveguide.

7. The system of claim 1, further comprising:
a tube assembly within the waveguide and containing the ultraviolet light source, the tube assembly including a wall that is at least partially transparent to ultraviolet light and microwave energy.

8. The system of claim 1, wherein the first chamber is located between the microwave source and the second chamber such that the microwave energy is generated by the microwave source and the microwave energy passes through the first chamber to the second chamber.

9. The system of claim 1, wherein the second chamber includes a plurality of tube assemblies extending therethrough and the ultraviolet light source comprises a plurality of ultraviolet light sources, each tube assembly comprising:
a tube assembly outlet;
a wall that is transparent to ultraviolet light and microwave energy; and
a respective one ultraviolet light source of the plurality of ultraviolet light sources, the respective one ultraviolet light source including internal gas that generates ultraviolet light upon contact with microwave energy;
wherein the microwave source is configured to radiate the microwave energy into the first chamber and into the plurality of tube assemblies such that the microwave energy contacts the plurality of ultraviolet light sources to cause the internal gas therein to generate ultraviolet light upon contact with the microwave energy.

10. The system of claim 1, further comprising:
a water source coupled to the inlet;
a gas separator coupled to the outlet and configured to separate hydrogen gas from oxygen gas.

11. The system of claim 10, wherein the gas separator is hydrocyclone.

12. The system of claim 10, wherein the gas separator includes a permeable membrane configured to at least partially separate the hydrogen gas from at least the oxygen gas such that the separated hydrogen gas ventilates through an outlet of the gas separator.

13. The system of claim 1, wherein the ultraviolet light source radiates the ultraviolet light having a wavelength range from about 150 nm to 200 nm.

14. (canceled)

15. The system of claim 1, wherein the second chamber is elongate and extends along a primary axis, the ultraviolet light source is elongate along the primary axis and resides within the second chamber along the primary axis, wherein the second chamber further includes:
a first electrode configured to have a negative charge; and
a second electrode configured to have a positive charge, the first electrode and the second electrode being external to the ultraviolet light source and internal to the waveguide;
wherein the first electrode is elongate along the primary axis and is arranged above the ultraviolet light source and the second electrode is elongate along the primary axis and is arranged below the ultraviolet light source.

16. The system of claim 1, wherein the second chamber forms a hydrocyclone.

17. The system of claim 16, wherein the ultraviolet light source resides on a vortex finder located within the hydrocyclone.

18. The system of claim 1, further comprising a permeable membrane residing within the second chamber, wherein the permeable membrane at least partially separates the hydrogen gas from at least the oxygen gas such that the separated hydrogen gas ventilates through the outlet of the second chamber.

19. A method comprising:
providing water into a first chamber adjacent to and in communication with a second chamber and a microwave source radiating microwave energy into the first chamber;
contacting the water with microwave energy generated by a microwave source;
providing the microwaved water to the second chamber, the second chamber including an outlet and a waveguide, wherein an ultraviolet light source resides within the waveguide of the second chamber; and
contacting the microwaved water with ultraviolet light within the second chamber, the ultraviolet light generated by the ultraviolet light source, the microwave source configured to radiate the microwave energy into the first chamber, wherein contacting of the water with the ultraviolet light causes the water to at least partially breakdown into hydrogen gas and oxygen gas.

20. The method of claim 19, further comprising separating the hydrogen gas from the oxygen gas.

21. (canceled).

22. The method of claim 21, wherein the second chamber comprises a permeable membrane, and wherein the permeable membrane at least partially separates the hydrogen gas from at least the oxygen gas such that the separated hydrogen gas ventilates through an outlet of the second chamber.

23. The method of claim 20, wherein the separation of hydrogen gas from the oxygen gas occurs within a gas separator that is coupled to and in fluid communication with the second chamber.

24. The method of claim 23, wherein the gas separator comprises a permeable membrane, and wherein the permeable membrane at least partially separates the hydrogen gas from at least the oxygen gas such that the separated hydrogen gas ventilates through an outlet of the gas separator.
